(19) United States
(12) Patent Application Publication
(10) Pub. No.: US 2019/0202428 A1
(43) Pub. Date: Jul. 4, 2019

(54) METHOD FOR CONTROLLING WHEELED ROBOT TO MOVE ALONG CIRCULAR TRAJECTORY

(71) Applicant: UBTECH Robotics Corp, Shenzhen (CN)

(72) Inventors: Youjun Xiong, Shenzhen (CN); Xiangnan Gu, Shenzhen (CN); Yanhui Zhang, Shenzhen (CN); Xianli Jiang, Shenzhen (CN)

(21) Appl. No.: 16/231,970

(22) Filed: Dec. 25, 2018

(30) Foreign Application Priority Data
Dec. 29, 2017 (CN) 201711483665.2

(51) Int. Cl. B60W 10/16; G05D 1/02; G01C 3/20

(52) U.S. Cl. CPC B60W 10/16; G05D 1/0223; G05D 2201/02; G01C 3/20; G05D 1/0236

(57) ABSTRACT

A method for controlling a wheeled robot to move along a circular trajectory includes: determining a first distance between a laser emitter and a center of a circular trajectory on a surface where the robot moves and a second, perpendicular distance from the laser emitter to the surface, calculating a radius of the circular trajectory based on the first distance and the second distance, calculating, based on the radius, a distance between a first wheel and a second wheel, a ratio of a first linear velocity of the first wheel to a second linear velocity of the second wheel, and determining a first rotational speed and a second rotational speed based on the ratio, and controlling the first servo to operate at the first rotational speed and the second servo to operate at the second rotational speed so as to drive the robot to move along the circular trajectory.

### CROSS REFERENCE TO RELATED APPLICATIONS

This application claims priority to Chinese Patent Application No. 201711483665.2, filed Dec. 29, 2017, which is hereby incorporated by reference herein as if set forth in its entirety.

### BACKGROUND

### Technical Field

The present disclosure generally relates to robots, and particularly to a method of controlling a robot to move along a circular trajectory.

### Description of Related Art

A common type of robot is the two-wheeled robot with independently controlled motors. This design uses differential steering and can turn when the two wheels are driven in the same direction and different speed. In certain circumstances, there exists a need for the two-wheeled robot to move along a circular trajectory.

### BRIEF DESCRIPTION OF DRAWINGS

Many aspects of present embodiments can be better understood with reference to the following drawings. Components in the drawings are not necessarily drawn to scale, the emphasis placed upon clearly illustrating principles of the present embodiments. Moreover, in the drawings, all views are schematic, and like reference numerals designate corresponding parts throughout several views.

FIG. 1 is a schematic block diagram of a robot according to an embodiment.

FIG. 2 is a flowchart of a method of controlling the robot of FIG. 1 according to a first embodiment.

FIG. 3 is a schematic diagram showing the principle of how the radius of a circular trajectory along which the robot of FIG. 1 moves is determined.

FIG. 4 is a flowchart of a method of controlling the robot of FIG. 2 according a second embodiment.

FIG. 5 is a schematic diagram of a device for controlling the robot of FIG. 1 according to a first embodiment.

FIG. 6 is a schematic diagram of a device for controlling the robot of FIG. 2 according to a second embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

In the field of robotics, there are many types of robots. According to application environment, robots can be divided into two categories, namely industrial robots and special robots. The industrial robots are multi-joint robots or multi-degree-of-freedom robots for the industrial field. Special robots are advanced robots that are used in non-manufacturing and serve humans. According to propelling mechanism, robots can be divided into wheeled robots, tracked robots and legged robots. The tracked robots can better adapt to soft terrain, such as sand and mud. The contact areas between the tracks of the tracked robots and the support surface is large and stable. A disadvantage of the tracked robots is that they are not suitable for uneven terrain. The two-legged robots can adapt to almost all kinds of complex terrains and can step over obstacles. A disadvantage of the two-legged robots is that they travel at low speed, and may tend to fall over due to high center of gravity. Wheeled robots are more suitable for even roads and can move at high speed.

When wheeled robots move, they move by the wheels mounted on the bottom of a robot body. The wheels can be in the form of two rows of wheels mounted on the left and right sides of the robot body. There are also four-wheel drive robots that transmits power through four wheels, which greatly improves the adaptability to wet icy and uneven road surfaces, and allow the robots to climb up steep slopes that the two-wheel drive robots cannot manage.

A wheeled robot according to an embodiment includes two wheels. The distance between the two wheels is constant and will be hereinafter referred to as “wheel distance”. In general, a wider wheel distance provides better stability, and provides better support when the robot is moving. When the robot with wide wheel distance makes a turn or a move along a circular trajectory, the tilt angle of the robot is smaller, the limit of the outer wheel will also appear later, and the speed difference between the two wheels will be small. Therefore, the wheel distance of the robot will affect the speed of the left and right wheels when the robot moves along a circular trajectory.

When the robot is moving, by controlling the rotational speed of the wheels of the robot, the robot can be controlled to make a turn or move along a circular trajectory. The difference between the distances that the two wheels has traveled in the same time increases as the difference between the rotational angular velocities of the two wheels increases. That is, the difference in arc length between the arcs the two wheels has traveled increases as the difference between the rotational angular velocities of the two wheels increases. A greater difference between the rotational angular velocities of the two wheels can cause the robot to make a sharper turn or move along a smaller-radius circular trajectory. Accordingly, the radius of the circular trajectory can be controlled by controlling the rotational speed of the two wheels of the robot, or the proportional relationship between the rotational speeds of the two wheels.

In the embodiment, a laser emitter is mounted on the body of the robot. The laser emitter is located on an imaginary line that is vertical and perpendicularly intersects with an imaginary line defined by centers of the two wheels of the robot, and the height of the laser emitter is not limited and can be determined according to actual need. The laser emitter can be controlled to emit a light that is directed to a location on the surface where the robot moves so that the distance from the location to the laser emitter can be measured. Specifically, two of the most important techniques used for laser distance meters are as follows: time-of-flight measurements and phase shift method. Time-of-flight measurements are based on measuring the time of flight of a laser pulse from the measurement device to some target and back again. The phase shift method uses an intensity-modulated laser beam. One measures the phase shift of an intensity modulation which is related to the time of flight. Since the two distance measurements with lasers have been well known and widely discussed, they will not be described in detail here. The laser emitter has the advantages of light weight and small volume, and can be conveniently installed on the robot without affecting its normal operation. Moreover, the laser emitter is simple, fast and accurate, and its measurement error is only one-fifth to one-hundredth of that of other optical range finder, which can efficiently and accurately measure the distance from the target position to itself.

By pre-acquiring the height of the laser emitter, that is, the vertical distance of the laser emitter to the surface where the robot moves, the horizontal distance from the robot to a target position can be determined based on the height of the laser emitter and the distance from the target position to the laser emitter according to the Pythagorean theorem. Specifically, the vertical distance from the laser emitter to the surface is a leg of a right triangle, and the distance from the laser emitter to the target position is the hypotenuse of the right triangle, and the other leg calculated according to the Pythagorean theorem is the horizontal distance from the robot to the target position. Through the distance calculation method above, the distance from the robot to any target position on the surface can be determined with improved measurement accuracy.

The two wheels of the robot both include a speed sensor for measuring the rotational speed of each wheel. The linear velocity of each wheel can then be determined by multiplying the radius and the rotational speed of each wheel.

A user can control the laser emitter or other pointing device to emit light toward the surface where the robot moves to form a light spot thereon so as to select a target position indicated by the light spot as a center of a circular trajectory. The robot recognizes the target position, and acquires the position information of the target position.

In one embodiment, a first distance from the laser emitter to the desired center and a second vertical distance from the laser emitter to the surface where the robot moves are first determined. The radius of the circular trajectory is then calculated based on the first distance and the second distance. The ratio of the first linear velocity of the first wheel to the second linear velocity of the second wheel is calculated. Finally, a first rotational speed and a second rotational speed are determined based on the ratio, and the first servo for driving the first wheel is controlled to operate at the first rotational speed and the second servo for driving the second wheel is controlled to operate at the second rotational speed so as to drive the robot to move along the circular trajectory.

With such configuration, the two-wheeled robot can be controlled to move along a circular trajectory about a center selected by a user.

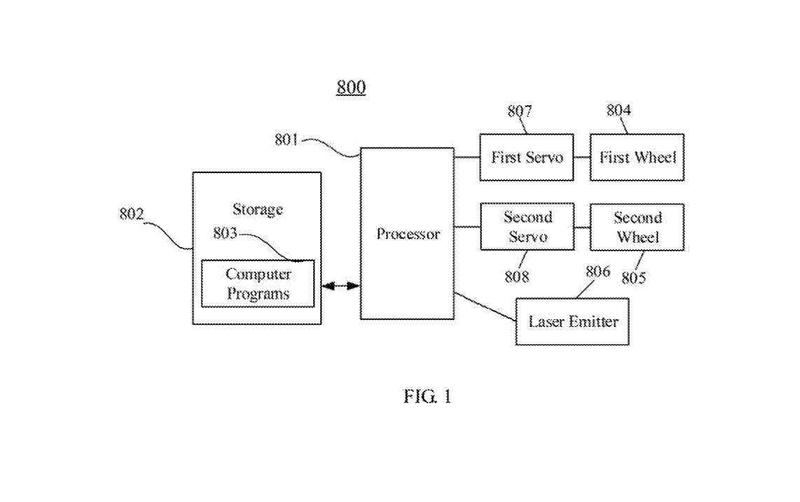

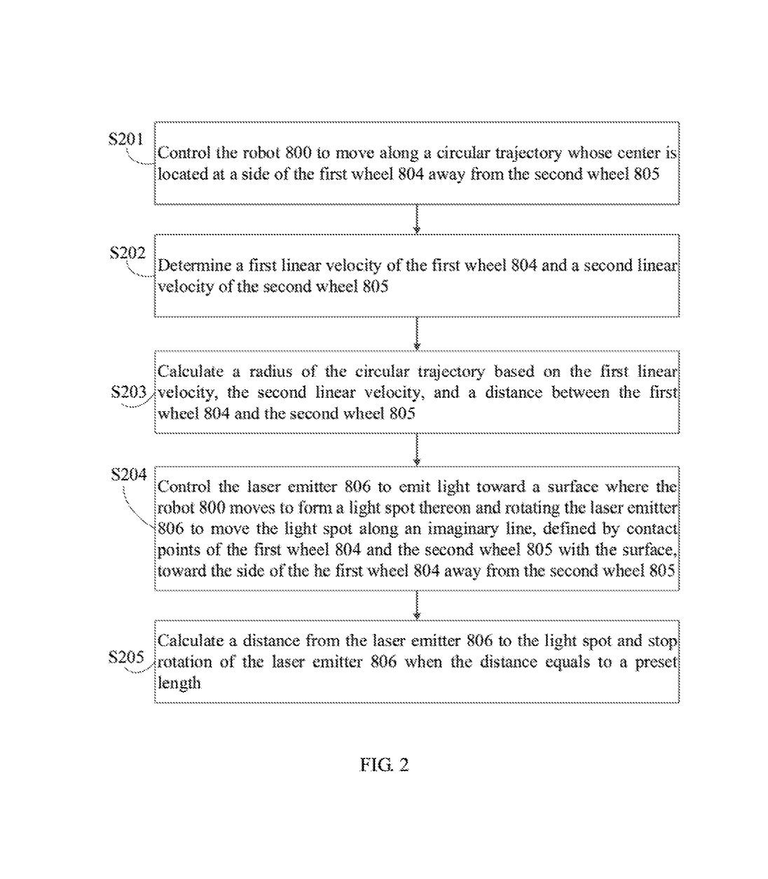

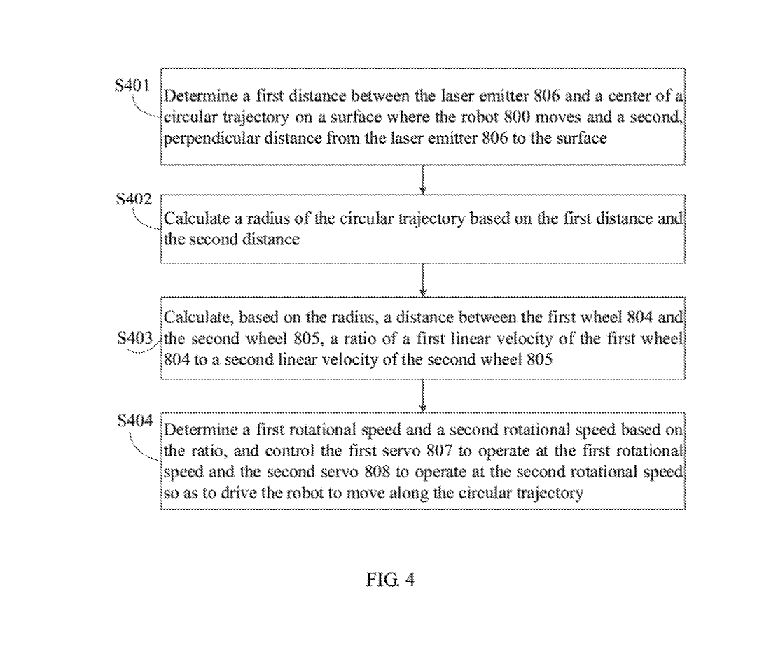

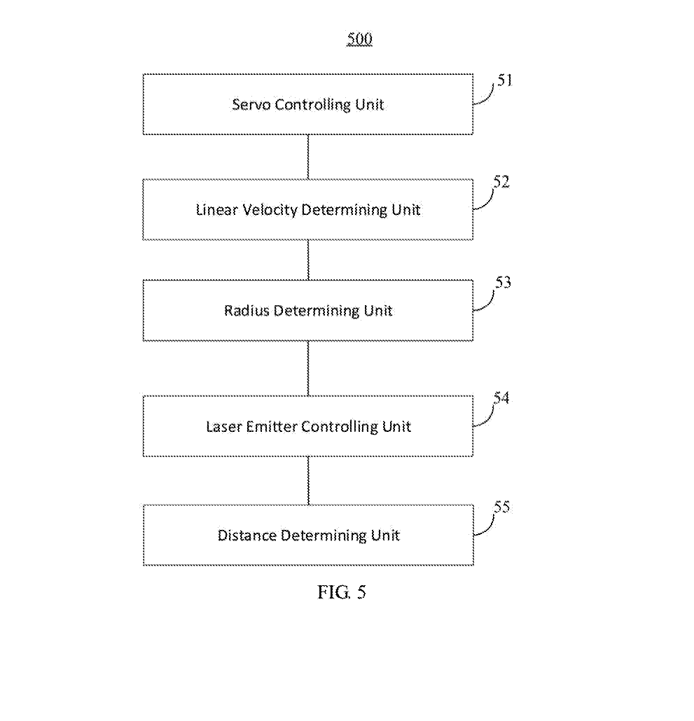

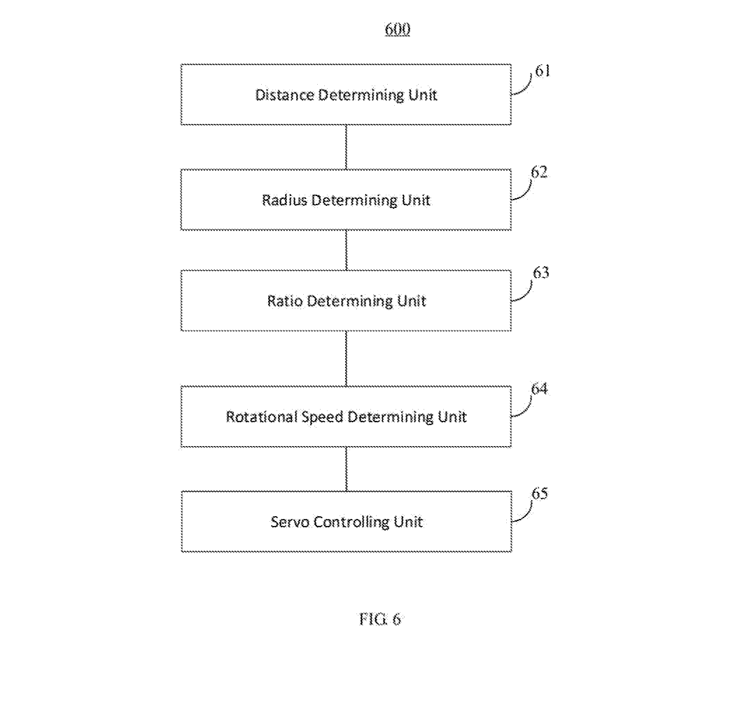

Referring to FIG. 1, in one embodiment, a robot 800 includes a processor 801, a storage 802, one or more computer programs 803 stored in the storage 802 and executable by the processor 801. The robot 800 further includes a first wheel 804, a second wheel 805, a laser emitter 806, a first servo 807 for driving the first wheel 804 and a second servo 808 for driving the second wheel 805. When the processor 801 executes the computer programs 803, steps from Step S201 to S205 as shown in FIG. 2, or steps from Step S401 to S404 as shown in FIG. 4, and functions of modules/units such as the units 51 to 55 in FIG. 5 and functions of modules/units 61 to 65 in FIG. 6 are implemented. The robot 800 is a differential wheeled robot, i.e. a mobile robot whose movement is based on two separately driven wheels placed on either side of the robot body. It can thus change its direction by varying the relative rate of rotation of its wheels and hence does not require an additional steering motion.

The processor 801 may be a central processing unit (CPU), a general purpose processor, a digital signal processor (DSP), an application specific integrated circuit (ASIC), a field-programmable gate array (FPGA), a programmable logic device, a discrete gate, a transistor logic device, or a discrete hardware component. The general purpose processor may be a microprocessor or any conventional processor or the like.

The storage 802 may be an internal storage unit of the robot 800, such as a hard disk or a memory. The storage 802 may also be an external storage device of the robot 800, such as a plug-in hard disk, a smart memory card (SMC), and a secure digital (SD) card, or any suitable flash cards. Furthermore, the storage 802 may also include both an internal storage unit and an external storage device. The storage 802 is used to store computer programs, other programs, and data required by the robot. The storage 802 can also be used to temporarily store data that have been output or is about to be output.

The wheels 804 and 805 are mounted on opposite sides of a robot body. Wheels are the most common way to move a bot. For wheeled robots, their drive geometry is defined by how each one is steered. There are a lot of choices. The most common way to move a robot is with differential steering. It's called differential steering because the robot is steered by changing the speed and direction (“difference”) between these two wheels. One of the key benefits of differential steering is that the robot can spin in place by reversing one wheel relative to the other. A feature of most differentially-steered robots is that they use one or two casters (or skids) placed center-line over the robot in the front and/or back to provide balancing support for the base.

The laser emitter 806 is rotatably connected to the body of the robot 800. The laser emitter 806 is located on an imaginary line that is vertical and perpendicularly intersects with an imaginary line defined by centers of the two wheels of the robot, and the height of the laser emitter is not limited and can be determined according to actual need. The laser emitter 806 is electrically coupled to the processor 801. The laser emitter 806 can be controlled by the processor 801 to emit a light that is directed to a location on the surface where the robot 800 moves so that the distance from the location to the laser emitter 806 can be measured. The laser emitter 806 can also be controlled by the processor 801 to rotate such that light spot form on the surface can move, which allows distances from various positions on the surface to the laser emitter 806 can be measured.

The servos 807 and 808 are used to respectively drive the wheels 804 and 805. In the embodiment, the servos 807 and 808 are respectively directly coupled to the wheels 804 and 805. The servos 807 and 808 are electrically connected to the processor 801 and operate as controlled by the processor 801.

It will be understood by those skilled in the art that FIG. 1 is merely an example of the robot 800, and does not limit the robot 800. The robot 800 may include components different in numbers from those illustrated, or incorporate some other different components. For example, the robot 800 may also include an input and output device, a network access device, a bus, and the like.

Referring to FIG. 2, in one embodiment, a method for controlling the robot 800 includes steps as follows.

Step S201: Control the robot 800 to move along a circular trajectory whose center is located at a side of the first wheel 804 away from the second wheel 805. As described above, the robot 800 is steered by changing the speed and direction between these two wheels. When the wheels 804 and 805 rotate in the same direction and different speed, the robot 800 will travel along a circular trajectory. In the embodiment, the rotational speed of the second wheel 805 is greater than that of the first wheel 805. In this case, the center is located at a side of the first wheel 804 away from the second wheel 805.

Step S202: Determine a first linear velocity of the first wheel 804 and a second linear velocity of the second wheel 805.

In one embodiment, the two wheels 804 and 805 both include a linear velocity sensor for measuring the linear velocity of the wheels 804 and 805. Technology choices for linear velocity sensors include: cable extension, magnetic induction, microwave, optical, or laser, piezoelectric radar or radio frequency, strain gauge and ultrasonic. Since linear velocity sensors are well known and widely used in a variety of fields, they will not be described in detail here.

In an alternative embodiment, the two wheels 804 and 805 both include a speed sensor for measuring the rotational speed of each wheel 804/805. The linear velocity of each wheel 804/805 can then be determined by multiplying the radius and the rotational speed of each wheel 804/805.

Step S203: Calculate a radius of the circular trajectory based on the first linear velocity, the second linear velocity, and a distance between the first wheel 804 and the second wheel 805.

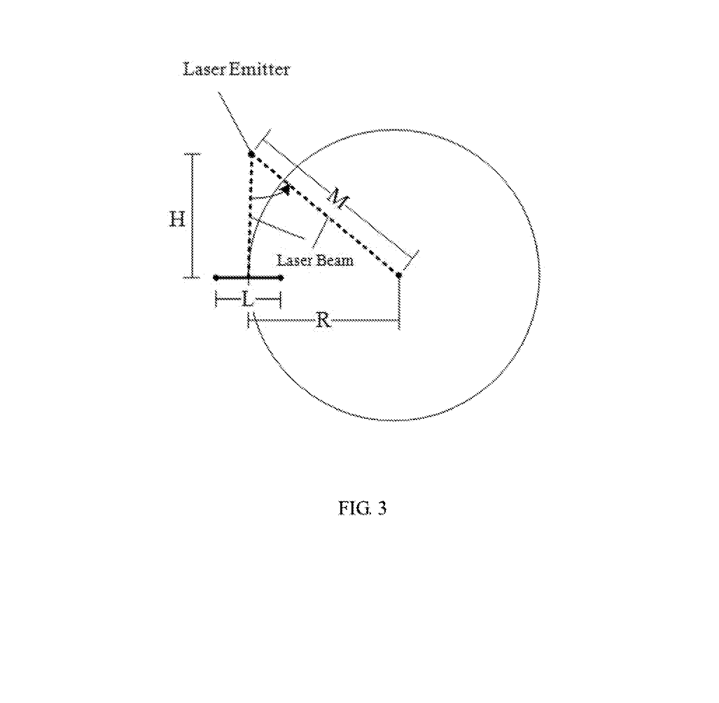

Referring to FIG. 3, L represents the distance (i.e. wheel distance) between the wheels 804 and 805 of the robot 800, and R represents the distance between the midpoint of a line defined by centers of the wheels 804 and 805 and the center of the circular trajectory. The wheels 804 and 805 are respectively considered as a mass point that spin about their own axes at the first linear velocity V_{L} and the second linear velocity V_{R}. The two mass points as a whole revolves about the center of the circular trajectory and thus they revolve about the center at the same angular velocity. The angular velocity is calculated according to a formula as follows:

$$w = \frac{{V}_{R} - {V}_{L}}{L} = \frac{{V}_{R}}{R - \frac{L}{2}} = \frac{{V}_{L}}{R + \frac{L}{2}} ,$$

where w represents the angular velocity, L represents the distance (i.e. wheel distance) between the wheels 804 and 805 of the robot 800, and R represents the distance between the midpoint of a line defined by centers of the wheels 804 and 805 and the center of the circular trajectory. That is, R represents the radius of the circular trajectory and can be calculated as follows:

$$R = \frac{L}{2} * \frac{{V}_{R} + {V}_{L}}{{V}_{R} - {V}_{L}} .$$

Step S204: Control the laser emitter 806 to emit light toward a surface where the robot 800 moves to form a light spot thereon and rotating the laser emitter 806 to move the light spot along an imaginary line, defined by contact points of the first wheel 804 and the second wheel 805 with the surface, toward the side of the first wheel 804 away from the second wheel 805.

Referring also to FIG. 3. the wheels 804 and 805 are respectively considered as a mass point that spin about their own axes at the first linear velocity V_{L} and the second linear velocity V_{R}. In FIG. 3, R represents the radius of the circular trajectory, H represents the perpendicular distance from the laser emitter 806 to the surface where the robot 800 moves, i.e. the height of the laser emitter 806, M represents the distance from the desired center of the circular trajectory to the laser emitter 806, i.e. a benchmark length. The imaginary lines between each two of the laser emitter 806, the center of the circular trajectory, and the projection of the laser emitter 806 on the surface constitute a right triangle. The length of the legs respectively equal to H and R and the length of the hypotenuse equals to M. Thus, the hypotenuse can be calculated according to formula as follows: M=\sqrt{R²+H²}.

Step S205: Calculate a distance from the laser emitter 806 to the light spot and stop rotation of the laser emitter 806 when the distance equals to a preset length.

In the embodiment, the preset length equals to the benchmark length. During the rotation of the laser emitter 806, the distance from the laser emitter 806 to the light spot is calculated in real time and compared with the preset length. When the distance from the laser emitter 806 to the light spot equals to the preset length, it means that the light spot moves to the center of the circular trajectory. The rotation of the laser emitter 806 is sopped and the light spot indicates the center of the circular trajectory.

With the above method, the center of the circular trajectory that the robot moves along can be found and indicated by a laser spot on the surface where the robot moves.

Referring to FIG. 4, in one embodiment, a method for controlling the robot 800 to move along a circular trajectory includes steps as follows.

Step S401: Determine a first distance between the laser emitter 806 and a center of a circular trajectory on a surface where the robot 800 moves and a second, perpendicular distance from the laser emitter 806 to the surface.

In the embodiment, the robot 800 includes an identification device by which the position of the center of the desired circular trajectory is determined. The center of the circular trajectory is selected by a user who uses a pointing device to emit light toward the surface where the robot 800 moves to form a light spot thereon so as to select a desired position indicated by the light spot as a center of the circular trajectory.

In one embodiment, the robot 800 takes a photo or video of the current field of view, and recognizes in real time whether there exists a light spot in the photo or video through image recognition technology. If so, the robot 800 identifies the position of the light spot, and determines that the position of laser spot is the center of the circular trajectory.

The information of the center of the circular trajectory can be determined by using the remaining objects in the environment as a reference object. It may also create a three-axis coordinate system based on environmental data in advance, and determine the coordinates of the light spot.

After the information of the center of the circular trajectory is determined, the light emitter 806 is controlled to emit light toward the center of the circular trajectory and calculate the first distance from the laser emitter 806 to the center of the circular trajectory. In the embodiment, the first distance is determined by measuring the time taken for a light pulse to travel from the laser emitter 806 to the center of the circular trajectory and back. With the speed of light known, and an accurate measurement of the time taken, the first distance can be calculated.

The second distance from the laser emitter 806 to the surface is also determined in the same way as the first distance. In an alternative embodiment, since the second distance is a constant value and can be measured in advanced and value can be stored in the storage 802 of the robot 800. In this case, the second distance is determined by accessing a particular address of the storage 802.

Step S402: Calculate a radius of the circular trajectory based on the first distance and the second distance.

In the embodiment, the radius of the circular trajectory is determined according to a formula as follows; R=\sqrt{M²−H²}, where R represents the radius of the circular trajectory, M represents the first distance, and H represents the second distance. It should be noted that the relationship between R, M and H has been discussed in detail in the foregoing paragraphs and will not be described here.

Step S403: Calculate, based on the radius, a distance between the first wheel 804 and the second wheel 805, a ratio of a first linear velocity of the first wheel 804 to a second linear velocity of the second wheel 805.

The ratio is calculated according to a formula as follows:

$$\frac{{V}_{L}}{{V}_{R}} = \frac{2 R - L}{2 R + L} ,$$

where V_{L} represents first linear velocity. V_{R} represents second linear velocity, R represents the radius of the circular trajectory, and L represents the distance (i.e. wheel distance) between the wheels 804 and 805 of the robot 800. It should be noted that the relationship between V_{L}, V_{R}, R, and L has been discussed in detail in the foregoing paragraphs and will not be described here.

Step S404: Determine a first rotational speed and a second rotational speed based on the ratio, and control the first servo 807 to operate at the first rotational speed and the second servo 808 to operate at the second rotational speed so as to drive the robot to move along the circular trajectory.

In the embodiment, the motor of each servos 807 and 808 is a permanent magnet direct current (PMDC) motor, such as a DC brushed hollow cup motor. DC motors have a linear characteristic between rotational speed and torque and between torque and current, and thus they have good controllability. The drive and control circuit is simpler than other motors. The drive control can be current control mode and voltage control mode. The servo motor control is implemented in a voltage control mode, that is, the rotational speed is proportional to operating voltage. The drive is a bipolar drive method employing four power switches forming an H-bridge circuit. The pulse width modulation technique is used to adjust the magnitude and polarity of the voltage supplied to the DC motor to control the speed and direction of rotation (forward/reverse) of the motor. The speed of the motor depends on the magnitude of the average voltage applied to the motor, i.e. the duty ratio of the drive waveform (duty ratio is the percentage of pulse width/period) during pulse width modulation. When the duty ratio is increased, the speed of the motor increases, and the speed of the corresponding wheel increases. When the duty ratio is reduced, the speed of the motor decelerates and the speed of the corresponding wheel decreases. Therefore, the speed of a certain wheel can be increased by increasing the speed of a corresponding servo motor, which can be achieved by increasing the operating voltage of the motor, reducing the resistance of the main circuit of the motor, or increasing the operating current of the motor. The speed of the wheels 804 and 805 can be controlled by controlling the speed of the servos of the robot 800, thus enabling the robot 800 to move along a desired circular trajectory.

With such method, the two-wheeled robot can be controlled to move along a circular trajectory about a center selected by a user.

FIG. 5 is a schematic diagram of a device 500 for controlling the robot 800 according to an embodiment. For convenience of description, only parts related to the embodiment of the present invention are shown. In the embodiment, the device 500 is installed in the robot 800.

The device 500 includes a servo controlling unit 51, a linear velocity determining unit 52, a radius determining unit 53, a laser emitter controlling unit 54, and a distance determining unit 55.

The servo controlling unit 51 is used to control the robot 800 to move along a circular trajectory whose center is located at a side of the first wheel 804 away from the second wheel 805.

The linear velocity determining unit 52 is used to determine a first linear velocity of the first wheel 804 and a second linear velocity of the second wheel 805.

The radius determining unit 53 is used to calculate a radius of the circular trajectory based on the first linear velocity, the second linear velocity, and a distance between the first wheel 804 and the second wheel 805.

The laser emitter controlling unit 54 is used to control the laser emitter 806 to emit light toward a surface where the robot 800 moves to form a light spot thereon and rotate the laser emitter 806 to move the light spot along an imaginary line, defined by contact points of the first wheel 804 and the second wheel 805 with the surface, toward the side of the first wheel 804 away from the second wheel 805.

The distance determining unit 55 is used to calculate a distance from the laser emitter 806 to the light spot and notify the laser emitter controlling unit 54 when the distance equals to a preset length. The laser emitter controlling unit 54 then stops rotation of the laser emitter 806 upon receiving notification from the distance determining unit 55.

FIG. 6 is a schematic diagram of a device 600 for controlling the robot 800 to move along a circular trajectory. For convenience of description, only parts related to the embodiment of the present invention are shown. In the embodiment, the device 600 is installed in the robot 800.

The device 600 includes a distance determining unit 61, a radius determining unit 62, a ratio determining unit 63, a rotational speed determining unit 64, and a servo controlling unit 65.

The distance determining unit 61 is used to determine a first distance between the laser emitter 806 and a center of a circular trajectory on a surface where the robot 800 moves and a second, perpendicular distance from the laser emitter 806 to the surface.

The radius determining unit 62 is used to calculate a radius of the circular trajectory based on the first distance and the second distance.

The ratio determining unit 63 is used to calculate, based on the radius, a distance between the first wheel 804 and the second wheel 805, a ratio of a first linear velocity of the first wheel 804 to a second linear velocity of the second wheel 805.

The rotational speed determining unit 64 is used to determine a first rotational speed and a second rotational speed based on the ratio.

The servo controlling unit 65 is used to control the first servo 807 to operate at the first rotational speed and the second servo 808 to operate at the second rotational speed so as to drive the robot to move along the circular trajectory.

A person skilled in the art can clearly understand that for convenience and brevity of descriptions, he/she can refer to the process in the foregoing method embodiments for a specific working process of the units described above, and details are not described herein again.

In the embodiments above, the descriptions of the various embodiments have their respective focuses. For parts that are not detailed or described in a certain embodiment, related descriptions in other embodiments may be referred to.

A person skilled in the art will understand that the modules, units and/or method steps described in connection with the embodiments disclosed herein can be implemented by electronic hardware or a combination of computer software and electronic hardware. Whether these functions are performed in hardware or software depends on specific applications and design constraints of technical solutions. A professional technical person can use different methods for implementing the described functions for each particular application, but such implementation should not be considered to be beyond the scope of the present invention.

It should be understood that, according to the embodiments of the present disclosure, the disclosed system, apparatus and methods may be implemented in other ways. For example, the described apparatus embodiment is merely exemplary. The division of the units is merely based on logical functions, and the units may be divided with other approaches in practice. For example, multiple units or modules may be combined, or may be integrated into another system, or some features may be omitted or not be implemented. In addition, displayed or discussed couplings, direct couplings or communication connections between individual components may be implemented via indirect couplings or communication connections between some interfaces, devices or units, which may be electrical, mechanical or in other forms.

The units described as separate components may be or may not be separated physically. The components shown as units may be or may not be physical units, i.e., the units may be located at one place or may be distributed onto multiple network units. All of or part of the units may be selected based on actual needs to implement the solutions according to the embodiments of the disclosure.

In addition, individual function units according to the embodiments of the disclosure may be integrated in one processing unit, or the units may exist separately, or two or more units may be integrated in one unit. The foregoing integrated units may be realized in a form of hardware, or realized in a form of software functional units.

If the integrated unit is implemented in the form of software function unit and the software function unit is sold or used as separate products, the software function unit may also be stored in a computer readable storage medium. Based on such understanding, the technical solutions of the disclosure or the part of the disclosure that contributes to conventional technologies or part of the technical solutions may be embodied in the form of a software product. The computer software product is stored in a storage medium and includes several instructions for instructing a computer device (which may be a personal computer, a server, a network device or the like) or a processor to implement all of or part of the steps of the methods according to the embodiments of the disclosure. The foregoing storage medium includes various media that can store programs, for example, USB disks, mobile hard disk drives, read-only memories (ROMs), random access memories (RAMs), magnetic disks, optical disks and the like.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A computer-implemented method for controlling a wheeled robot to move along a circular trajectory, the robot comprising a first wheel, a second wheel, a laser emitter, a first servo for driving the first wheel and a second servo for driving the second wheel, the method comprising:
determining a first distance between the laser emitter and a center of a circular trajectory on a surface where the robot moves and a second, perpendicular distance from the laser emitter to the surface;
calculating a radius of the circular trajectory based on the first distance and the second distance;
calculating, based on the radius, a distance between the first wheel and the second wheel, a ratio of a first linear velocity of the first wheel to a second linear velocity of the second wheel;
determining a first rotational speed and a second rotational speed based on the ratio, and controlling the first servo to operate at the first rotational speed and the second servo to operate at the second rotational speed so as to drive the robot to move along the circular trajectory.

2. The method according to claim 1, wherein the radius is calculated according to a first formula as follows: R=\sqrt{M²−H²}, where the R represents the radius of the circular trajectory, M represents the first distance, and H represents the second distance; the ratio is calculated according to a second formula as follows:
$$\frac{{V}_{L}}{{V}_{R}} = \frac{2 R - L}{2 R + L} ,$$
where L represents the distance between the first wheel and the second wheel, V_{L} represents the first linear velocity, and V_{R} represents the second linear velocity.

3. A computer-implemented method for controlling a wheeled robot, the robot comprising a first wheel, a second wheel, a laser emitter, a first servo for driving the first wheel and a second servo for driving the second wheel, the method comprising:
controlling the robot to move along a circular trajectory whose center is located at a side of the first wheel away from the second wheel;
determining a first linear velocity of the first wheel and a second linear velocity of the second wheel;
calculating a radius of the circular trajectory based on the first linear velocity, the second linear velocity, and a distance between the first wheel and the second wheel; and
controlling the laser emitter to emit light toward a surface where the robot moves to form a light spot thereon and rotating the laser emitter to move the light spot along an imaginary line, defined by contact points of the first wheel and the second wheel with the surface, toward the side of the first wheel away from the second wheel; and
calculating a distance from the laser emitter to the light spot and stopping rotation of the laser emitter when the distance equals to a preset length.

4. The method according to claim 3, wherein the radius of the circular trajectory is calculated according to a first formula as follows:
$$R = \frac{L}{2} * \frac{{V}_{R} + {V}_{L}}{{V}_{R} - {V}_{L}} ,$$
where R represents the radius of the circular trajectory, L represents the distance between the first wheel and the second wheel, V_{L} represents the first linear velocity, and V_{R} represents the second linear velocity; the preset length is calculated according to a second formula as follows: M=\sqrt{R²+H²}, where M represents the preset length, and H represents a perpendicular distance from the laser emitter to the surface.

5. A wheeled robot comprising:
a first wheel;
a second wheel;
a first servo configured to drive the first wheel;
a second servo configured to drive the second wheel;
a laser emitter configured to emit light toward a surface where the robot moves;
one or more processors;
a storage; and
one or more computer programs stored in the storage and configured to execute a method, the method comprising steps of:
determining a first distance between the laser emitter and a center of a circular trajectory on a surface where the robot moves and a second, perpendicular distance from the laser emitter to the surface;
calculating a radius of the circular trajectory based on the first distance and the second distance;
calculating, based on the radius, a distance between the first wheel and the second wheel, a ratio of a first linear velocity the first wheel to a second linear velocity of the second wheel;
determining a first rotational speed and a second rotational speed based on the ratio, and controlling the first servo to operate at the first rotational speed and the second servo to operate at the second rotational speed so as to drive the robot to move along the circular trajectory.

6. The wheeled robot according to claim 5, wherein the radius is calculated according to a first formula as follows: R=\sqrt{M²−H²}, where the R represents the radius of the circular trajectory, M represents the first distance, and H represents the second distance; the ratio is calculated according to a second formula as follows:
$$\frac{{V}_{L}}{{V}_{R}} = \frac{2 R - L}{2 R + L} ,$$
where L represents the distance between the first wheel and the second wheel, V_{L} represents the first linear velocity, and V_{R} represents the second linear velocity.
